(19) United States
(12) Patent Application Publication
(10) Pub. No.: US 2010/0026595 A1
(43) Pub. Date: Feb. 4, 2010

(54) ANTENNA DEVICE AND MOBILE WIRELESS TERMINAL

(76) Inventors: Hisashi Kondo, Tokyo (JP); Nobuya Harano, Shizuoka (JP)

Correspondence Address: Mr. Jackson Chen, 6535 N. STATE HWY 161, IRVING, TX, 75039, US

(21) Appl. No.: 12/515,916

(22) PCT Filed: Nov. 5, 2007
(86) PCT No.: PCT/JP2007/071853

§ 371 Date: May 21, 2009

(30) Foreign Application Priority Data
Nov. 27, 2006 (JP) 2006-317911

(51) Int. Cl. H01Q 1/12

(52) U.S. Cl. 343/729

(57) ABSTRACT

In an antenna device having a coil element 11 composed of metallic wire that is connected to a power feeding point by causing one end portion to be coupled to a caulking portion 13-1 of a power feeding plate 13 connected to the power feeding point on a circuit board 1, a plate element section 13-2 is constructed using a part of the power feeding plate 13 when an antenna element whose element length is different from that of the coil element 11 is added. This makes it possible to obtain the antenna device that can achieve a wider bandwidth while restraining the number of parts and a cost from being increased.

### TECHNICAL FIELD

The present invention relates to an antenna device and a mobile wireless terminal, and particularly, the present invention relates to an antenna device having an antenna element composed of metallic wire, which is connected to a power feeding point on a circuit board by causing one end portion to be connected to a metallic plate connected to the power feeding point.

### BACKGROUND ART

FIG. 1 is a view showing an internal configuration of a foldable type of mobile wireless terminal (for example, cellular phone) including a related antenna device. As shown in FIG. 1, this mobile wireless terminal includes: a circuit board 1 housed in a lower housing; a circuit board 2 housed in an upper housing; and a connecting member 3 for electrically connecting these circuit boards 1 and 2.

Further, the related antenna device includes a coil element 11, a power feeding plate 12, and a plate element 21.

The coil element 11 is an antenna element for a band from 800 to 900 MHz (GSM: Global System for Mobile Communication), for example. The plate element 21 is an antenna element for a band from 1.7 to 1.9 GHz (DCS: Digital Cellular System or PCS: Personal Communications Service), for example. Element lengths of the coil element 11 and the plate element 21 differ from each other. Further, the coil element 11 and the plate element 21 are respectively arranged left and right of one end of the circuit board 1 so that tips thereof face to each other.

The plate element 21 is composed of a metallic plate. One end of the plate element 21 is connected to ground of the circuit board 1, and the other end becomes an open end. A part of the plate element 21 combines with a plate for connecting the plate element 21 to the ground of the circuit board 1.

The coil element 11 is composed of metallic wire. Therefore, the coil element 11 cannot be connected to a signal wiring pattern on the circuit board 1 as it is. For that reason, the coil element 11 is electrically connected to the signal wiring pattern on the circuit board 1 via the power feeding plate 12. One end portion of the coil element 11 is connected to the power feeding plate 12 via a caulking portion 12-1 of the power feeding plate 12, and the other end becomes an open end.

The coil element 11 and the plate element 21 are arranged so as to be capacitively coupled to each other by causing the open end of the coil element 11 and the open end of the plate element 21 to be adjacent to each other. Thus, the plate element 21 functions as an antenna.

A conventional antenna device similar to this type of antenna device is described in Japanese Patent Application Publication No. 2006-033798, for example.

Next, the caulking portion 12-1 will be described in detail with reference to FIG. 2.

As shown in FIG. 2, one end portion of the coil element 11 forms an elastic portion 11-1 by being bent in a coil manner. On the other hand, the power feeding plate 12 includes a pair of folded portions 12-2 and 12-3 in the caulking portion 12-1. The folded portions 12-2 and 12-3 are folded on a plate surface of the power feeding plate 12 to hold the elastic portion 11-1 of the coil element 11 arranged on the plate surface. The elastic portion 11-1 is pressure-bonded to the folded portions 12-2 and 12-3 by form elasticity. Thus, the coil element 11 is mechanically and electrically connected to the power feeding plate 12 surely.

This type of caulking portion is described in Japanese Patent Application Publication No. 2006-081072, for example.

### DISCLOSURE OF THE INVENTION

In order to achieve a wider bandwidth of an antenna device, that is, the antenna device that can deal with more frequency bandwidth, an antenna element having a desired element length may be newly added and connected to a power feeding point (that is, a signal wiring pattern on a circuit board 1 of FIG. 1). However, in order to newly add and connect the antenna element to the power feeding point, a connecting part for ensuring connection to the power feeding point is also required, whereby the number of parts is increased and it leads to increase of a cost.

It is an object of the present invention to provide an antenna device and a mobile wireless terminal capable of achieving a wider bandwidth while restraining the number of parts and a cost from being increased.

An antenna device according to the present invention is an antenna device having a metallic plate and a first antenna element, the metallic plate being connected to a signal wiring pattern on a circuit board, the first antenna element being composed of metallic wire, one end portion of the first antenna element being connected to the metallic plate, the other end of the first antenna element being an open end, wherein the antenna device includes a plate-like second antenna element constructed by a part of the metallic plate, a tip of the second antenna element is an open end, and an element length of the second antenna element is different from that of the first antenna element.

Further, in the antenna device, the antenna device includes a third antenna element in which one end is connected to ground wiring of the circuit board and the other end is an open end, and an element length thereof is different from that of each of the antenna elements, wherein a distance between one of the open ends of the first and second antenna elements and the open end of the third antenna element is caused to be adjacent so as to be capacitively coupled to each other.

Further, in the antenna device, each of the antenna elements is arranged so that a direction of an antenna current thereof becomes parallel to one side of the circuit board.

Further, in the antenna device, the metallic plate further includes a plate-like fourth antenna element composed of a part of the metallic plate, a tip of the fourth antenna element is an open end, and an element length of the fourth antenna element is different from that of each of the antenna elements, wherein the fourth antenna element is arranged so that a direction of an antenna current thereof becomes parallel to the one side.

Further, in the antenna device, the antenna device further includes a fifth antenna element composed of metallic wire, one end portion of the fifth antenna element is connected to the metallic plate, the other end of the fifth antenna element is an open end, and an element length of the fifth antenna element is different from that of each of the antenna elements, wherein the fifth antenna element is arranged so that a direction of an antenna current thereof becomes parallel to the one side.

Further, in the antenna device, an elastic portion with form elasticity is provided on the one end portion of the first antenna element, and the metallic plate has a pair of folded portions folded on a plate surface of the metallic plate for holding the elastic portion placed on the plate surface.

A mobile wireless terminal according to the present invention includes the antenna device.

Thus, in the present invention, in the antenna device having the first antenna element composed of the metallic wire connected to the power feeding point by connecting one end portion to the metallic plate connected to the power feeding point on the circuit board, the second antenna element is constructed using a part of the above metallic plate when the second antenna element whose element length is different from that of the first antenna element is added.

According to the present invention, when an antenna element is added in order to achieve the antenna device that can deal with more frequency bandwidths, by constructing the antenna element using a part of the power feeding metallic plate, the effect that it is possible to achieve a wider bandwidth while restraining the number of parts and a cost from being increased can be obtained.

### BRIEF DESCRIPTION OF THE DRAWINGS

FIG. 1 is a view showing an internal configuration of a mobile wireless terminal including a related antenna device;

FIG. 2 is a view for explaining a caulking portion in the antenna device of FIG. 1;

FIG. 3 is a view showing an internal configuration of a mobile wireless terminal including an antenna device according to one embodiment of the present invention;

FIG. 4 is a view showing a configuration of a power feeding plate included in the antenna device of FIG. 3;

FIG. 5A is a graph showing impedance characteristics of the antenna device of FIG. 1;

FIG. 5B is a graph showing impedance characteristics of the antenna device of FIG. 3;

FIG. 6 is a view showing another constitutional example of the power feeding plate 13 used in the antenna device of FIG. 3;

FIG. 7 is a view showing still another constitutional example of the power feeding plate 13 used in the antenna device of FIG. 3;

FIG. 8 is a view showing still another constitutional example of the power feeding plate 13 used in the antenna device of FIG. 3; and

FIG. 9 is a view showing still another constitutional example of the power feeding plate 13 used in the antenna device of FIG. 3.

### BEST MODE FOR CARRYING OUT THE INVENTION

Hereinafter, an embodiment of the present invention will be described in detail with reference to the drawings.

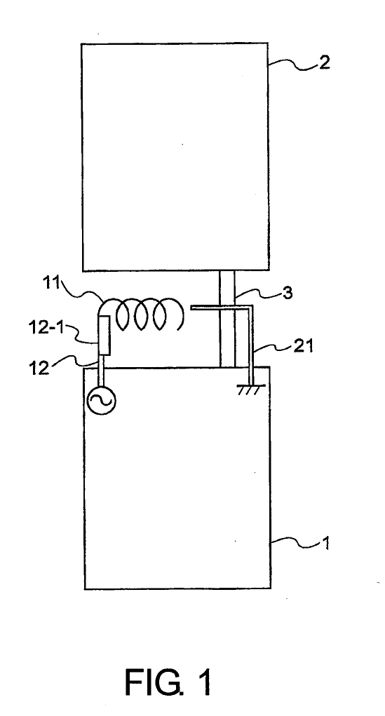

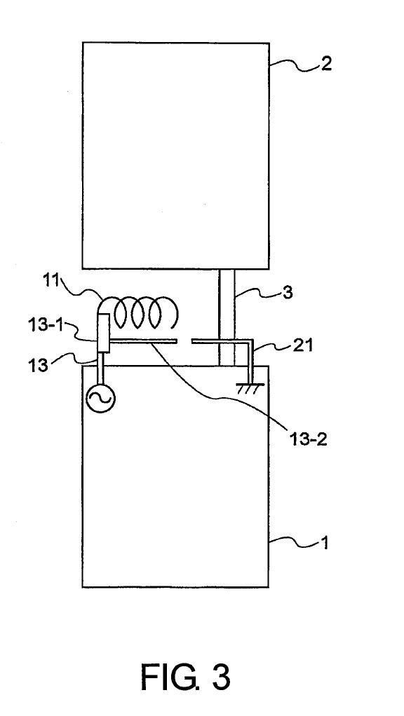

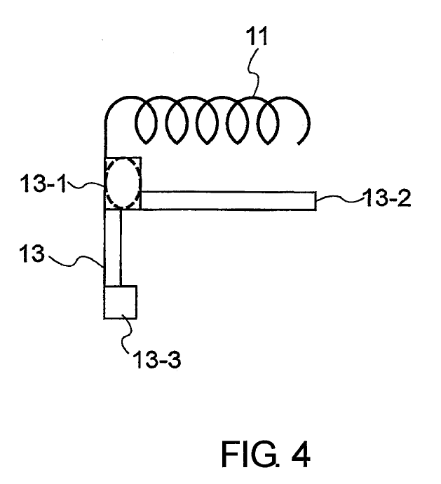

FIG. 3 is a view showing an internal configuration of a mobile wireless terminal that includes an antenna device according to an embodiment of the present invention. In FIG. 3, the same reference numerals are applied to portions similar to those in FIG. 1. An antenna device shown in FIG. 3 according to an embodiment of the present invention is different from the related antenna device shown in FIG. 1 on the point to have a power feeding plate 13 in place of the power feeding plate 12. FIG. 4 is a view showing a configuration of the power feeding plate 13 of FIG. 3.

As shown in FIGS. 3 and 4, the power feeding plate 13 has a plate element section 13-2 constructed by a part thereof. For example, the plate element section 13-2 is formed by folding the power feeding plate 13 of a predetermined shape. The plate element section 13-2 is an antenna element for a band from 1.9 to 2.1 GHz (W-CDMA: Wideband-Code Division Multiple Access), for example. An element length of the plate element section 13-2 is different from an element length of each of a coil element 11 and a plate element 21.

Each of the plate element section 13-2 and the coil element 11 is arranged so as to become parallel to one side of a circuit board 1. Namely, each of the plate element section 13-2 and the coil element 11 is arranged so that a direction of an antenna current in each of them becomes parallel to the one side of the circuit board 1. Further, a power feeding contact portion 13-3 of the power feeding plate 13 is a portion connected to a signal wiring pattern (power feeding point) on the circuit board 1.

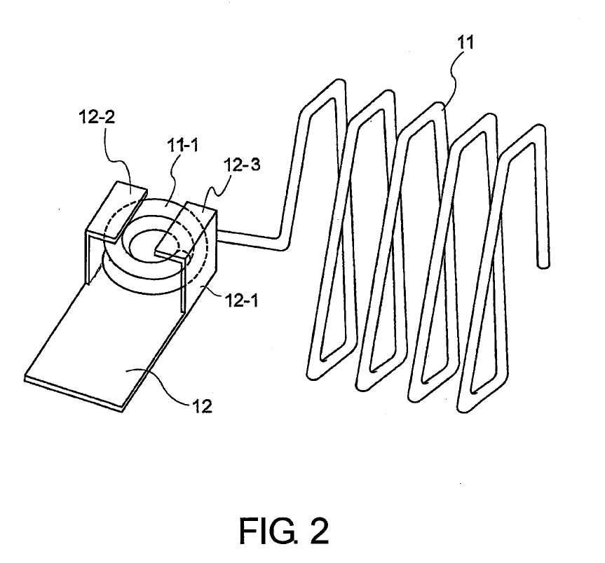

A configuration of a caulking portion 13-1 of the power feeding plate 13 for connecting the coil element 11 to the power feeding plate 13 is similar to that of the caulking portion 12-1 of FIG. 1. Namely, the caulking method that has been explained with reference to FIG. 2 is used for the caulking portion 13-1. In this regard, in FIG. 3, the plate element section 13-2 and the plate element 21 are arranged so that an open end that is a tip of the plate element section 13-2 is caused to be adjacent to an open end of the plate element 21 to be capacitively coupled to each other. However, an open end of the coil element 11 may be caused to be adjacent to the open end of the plate element 21 in the similar manner to FIG. 1. Further, in the case where the antenna for a band from 1.7 to 1.9 GHz (DCS/PCS) is not required, the plate element 21 may be eliminated.

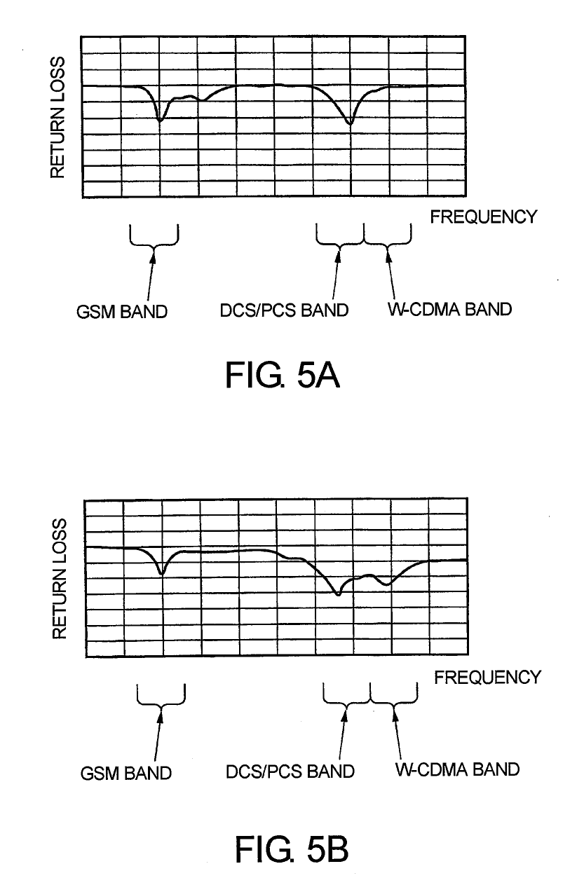

FIG. 5A is a graph showing impedance characteristics of the antenna device of FIG. 1, and FIG. 5B is a graph showing impedance characteristics of the antenna device of FIG. 3. As shown in FIG. 5A, the related antenna device of FIG. 1 has impedance characteristics corresponding to a GSM band and a DCS/PCS band, but does not have an impedance characteristic enough to cover a W-CDMA band. On the other hand, as can be understood from FIG. 5B, the antenna device of FIG. 3 according to the embodiment of the present invention has an impedance characteristic that can cover the W-CDMA band by the plate element section 13-2 composed of a part of the power feeding plate 13 in addition to the GSM band and the DCS/PCS band.

As explained above, in the antenna device according to the embodiment of the present invention, in order to deal with the band from 1.9 to 2.1 GHz (W-CDMA), the plate element section 13-2 is constructed using a part of the power feeding plate 13 without newly adding a plate element. Therefore, it is possible to reduce a cost compared with the case a plate element is newly added. Further, since the power feeding plate 13 is used for the coil element 11, there is no need to newly ensure connection to the circuit board 1, and a new connecting part is not required, whereby it is possible to restrain the number of parts from being increased.

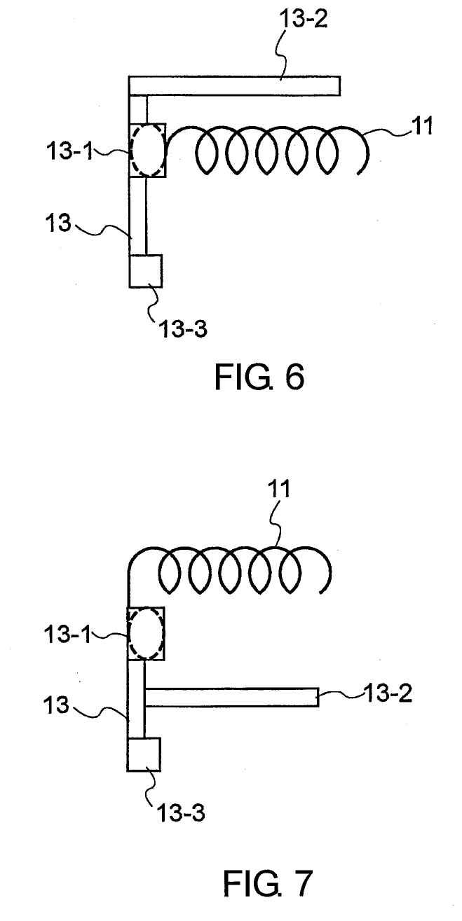

FIG. 6 is a view showing another constitutional example of the power feeding plate 13 used in the antenna device of FIG. 3. As shown in FIG. 6, a plate element section 13-2 constructed by a part of a power feeding plate 13 may be arranged at a position apart from the circuit board 1 (power feeding contact portion 13-3) compared with a coil element 11. In this regard, an open end of a plate element 21 may be caused to be adjacent to either an open end of the coil element 11 or an open end of the plate element section 13-2. Further, in the case where the antenna for a band from 1.7 to 1.9 GHz (DCS/PCS) is not required, the plate element 21 may be eliminated.

FIG. 7 is a view showing still another constitutional example of the power feeding plate 13 used in the antenna device of FIG. 3. As shown in FIG. 7, a plate element section 13-2 constructed by a part of a power feeding plate 13 may be arranged at a position not near a caulking portion 13-1 but near a circuit board 1 (power feeding contact portion 13-3) compared with the caulking portion 13-1. In this regard, an open end of a plate element 21 may be caused to be adjacent to either an open end of a coil element 11 or an open end of the plate element section 13-2. Further, in the case where the antenna for a band from 1.7 to 1.9 GHz (DCS/PCS) is not required, the plate element 21 may be eliminated.

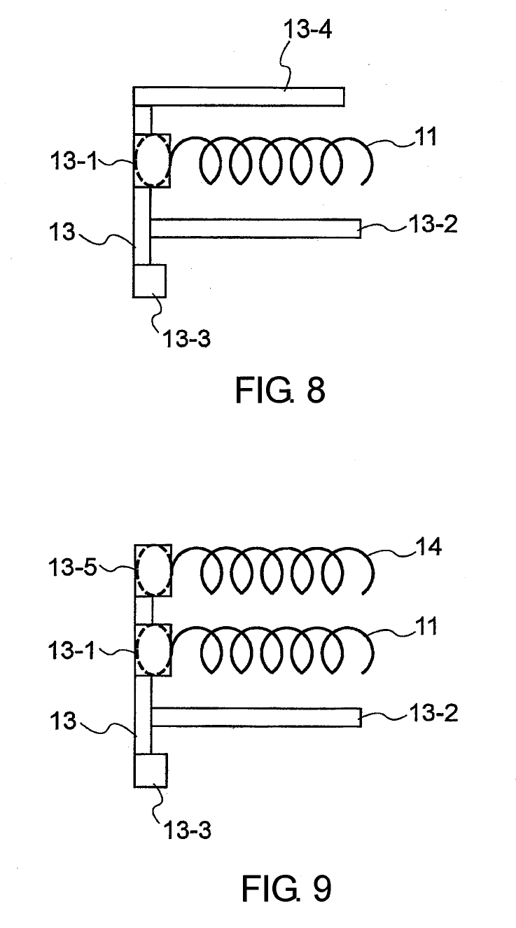

FIG. 8 is a view showing still another constitutional example of the power feeding plate 13 used in the antenna device of FIG. 3. As shown in FIG. 8, a plate element section 13-2 constructed by a part of a power feeding plate 13 is arranged at a position not near a caulking portion 13-1 but near a circuit board 1 (power feeding contact portion 13-3) compared with the caulking portion 13-1 in the similar manner to FIG. 7. Moreover, the power feeding plate 13 has a plate element section 13-4 constructed by a part thereof at a position apart from the circuit board 1 (power feeding contact portion 13-3) compared with a coil element 11.

An element length of the plate element section 13-4 is different from an element length of each of the coil element 11, the plate element section 13-2 and a plate element 21. Further, the plate element section 13-4 is arranged so that a direction of an antenna current thereof becomes parallel to one side of the circuit board 1. In this regard, an open end of the plate element 21 may be caused to be adjacent to any of an open end of the coil element 11, an open end of the plate element section 13-2 and an open end of the plate element section 13-4. Further, in the case where the antenna for a band from 1.7 to 1.9 GHz (DCS/PCS) is not required, the plate element 21 may be eliminated.

FIG. 9 is a view showing still another constitutional example of the power feeding plate 13 used in the antenna device of FIG. 3. As shown in FIG. 9, a plate element section 13-2 constructed by a part of a power feeding plate 13 is arranged at a position not near a caulking portion 13-1 but near a circuit board 1 (power feeding contact portion 13-3) compared with the caulking portion 13-1 in the similar manner to FIG. 7. Moreover, the power feeding plate 13 is provided with two caulking portions 13-1 and 13-5. The caulking portion 13-5 then holds one end portion of a coil element 14 composed of metallic wire in the similar manner to the caulking portion 13-1. Thus, the coil element 14 is connected to a signal wiring pattern (power feeding point) on the circuit board 1 via the power feeding plate 13.

An element length of the coil element 14 is different from an element length of each of the coil element 11, the plate element section 13-2 and a plate element 21. Further, the coil element 14 is arranged so that a direction of an antenna current thereof becomes parallel to one side of the circuit board 1. In this regard, an open end of the plate element 21 may be caused to be adjacent to any of an open end of the coil element 11, an open end of the coil element 14 and an open end of the plate element section 13-2. Further, in the case where the antenna for a band from 1.7 to 1.9 GHz (DCS/PCS) is not required, the plate element 21 may be eliminated.

This application is based upon and claims the benefit of priority from Japanese patent application No. 2006-317911, filed Nov. 27, 2006, the disclosure of which is incorporated herein in its entirety by reference.

1. An antenna device having a metallic plate and a first antenna element, the metallic plate being connected to a signal wiring pattern on a circuit board, the first antenna element being composed of metallic wire, one end portion of the first antenna element being connected to the metallic plate, the other end of the first antenna element being an open end,
wherein the antenna device includes a plate-like second antenna element constructed by a part of the metallic plate, a tip of the second antenna element is an open end, and an element length of the second antenna element is different from that of the first antenna element.

2. The antenna device as claimed in claim 1, wherein an elastic portion with form elasticity is provided on the one end portion of the first antenna element, and the metallic plate has a pair of folded portions folded on a plate surface of the metallic plate for holding the elastic portion placed on the plate surface.

3. The antenna device as claimed in claim 2, wherein the antenna device includes a third antenna element in which one end is connected to ground wiring of the circuit board and the other end is an open end, and an element length thereof is different from that of each of the antenna elements,
wherein one of the open ends of the first and second antenna elements is caused to be adjacent to the open end of the third antenna element so as to be capacitively coupled to.

4. The antenna device as claimed in claim 2, wherein each of the antenna elements is arranged so that a direction of an antenna current thereof becomes parallel to one side of the circuit board.

5. The antenna device as claimed in claim 4, wherein the metallic plate further includes a plate-like fourth antenna element composed of a part of the metallic plate, a tip of the fourth antenna element is an open end, and an element length of the fourth antenna element is different from that of each of the antenna elements,
wherein the fourth antenna element is arranged so that a direction of an antenna current thereof becomes parallel to the one side.

6. The antenna device as claimed in claim 4, wherein the antenna device further includes a fifth antenna element composed of metallic wire, one end portion of the fifth antenna element is connected to the metallic plate, the other end of the fifth antenna element is an open end, and an element length of the fifth antenna element is different from that of each of the antenna elements,
wherein the fifth antenna element is arranged so that a direction of an antenna current thereof becomes parallel to the one side.

7. A mobile wireless terminal comprising the antenna device as claimed in claim 1.
